(19) United States
(12) Patent Application Publication
(10) Pub. No.: US 2026/0167062 A1
(43) Pub. Date: Jun. 18, 2026

(54) LEG SUPPORT FOR VEHICLE SEATING ASSEMBLY

(71) Applicant: Ford Global Technologies, LLC, Dearborn, MI (US)

(72) Inventors: Johnathan Andrew Line, Northville, MI (US); Jimmy Moua, Superior Township, MI (US); Chris Fredriksson, LaSalle (CA); Chuck R. Reese, Whitmore Lake, MI (US); Luke Gajda, Royal Oak, MI (US); Cesar Adrian Davila Garcia, Tlalnepantla (MX); David Zorrilla, Mexico City (MX); Jose Fernando Ovando Sanchez, Toluca (MX)

(73) Assignee: Ford Global Technologies, LLC, Dearborn, MI (US)

(21) Appl. No.: 18/983,784

(22) Filed: Dec. 17, 2024

(51) Int. Cl. B60N 2/02; B60N 2/62

(52) U.S. Cl. CPC B60N 2/0284; B60N 2/62

(57) ABSTRACT

A vehicle seating assembly includes a seat base having a forward portion and a rearward portion. The seat base is operable between a seated position and a reclined position. A seat pan is operably coupled to the seat base. A first support assembly includes a first portion and a second portion. The first support assembly is operably coupled to the seat pan and is translatable relative to the seat pan. A second support assembly is operably coupled to the first support assembly and translatable relative to the first support assembly. The first support assembly and the second support assembly extend from the forward portion of the seat base.

### FIELD OF THE DISCLOSURE

The present disclosure generally relates to a vehicle seating assembly and, more particularly, to a leg support assembly for the vehicle seating assembly.

### BACKGROUND OF THE DISCLOSURE

Conventional vehicle seating can include a seat base, a seatback, and a leg support providing comfort and support to a passenger's legs. An enhanced support arrangement for the legs of the passenger is desired.

### SUMMARY OF THE DISCLOSURE

According to a first aspect of the present disclosure, a vehicle seating assembly includes a seat base having a forward portion and a rearward portion. The seat base is operable between a seated position and a reclined position. A seat pan is operably coupled to the seat base. A first support assembly includes a first portion and a second portion. The first support assembly is operably coupled to the seat pan and is translatable relative to the seat pan. A second support assembly is operably coupled to the first support assembly and translatable relative to the first support assembly. The first support assembly and the second support assembly extend from the forward portion of the seat base.

Embodiments of the first aspect of the present disclosure can include any one or a combination of the following features:
the first support assembly and the second support assembly are operable between a stowed position when the seat base is in the seated position and a deployed position when the seat base is in the reclined position;
the second support assembly includes a body having a top surface and a bottom surface, and the top surface of the second support assembly engages the second portion of the first support assembly;
a first tread operably coupled to the first portion and the second portion of the first support assembly, and a second tread operably coupled to the second support assembly, each of the first tread and the second tread include a foam portion;
a support cushion includes an upper portion and a lower portion to cover the first support assembly and the second support assembly, and the first tread is positioned proximate the upper portion and the second tread is positioned proximate the lower portion of the support cushion;
the upper portion and the lower portion of the support cushion define an arcuate surface, and the first tread and the second tread are configured to form tension along the arcuate surface during movement of the first support assembly and the second support assembly;
the first support assembly includes a first actuator disposed in a cavity defined by the first portion and the second portion;
the body of the second support assembly defines an interior, and a second actuator is disposed in the interior of the second support assembly;
the first support assembly and the second support assembly translate in a vehicle-forward direction to a first position when the seat base is in the reclined position;
the second support assembly translates in a vehicle-forward direction to a second position such that the second support assembly extends beyond the first support assembly in the first position;
the first support assembly and the second support assembly are operable between a stowed position and a deployed position; and
the first support assembly and the second support assembly are in the deployed position when the first support assembly is in the first position and the second support assembly is in a third position.

According to a second aspect of the present disclosure, a vehicle seating assembly includes a seat base including a forward portion and a rearward portion, the seat base is operable between a seated position and a reclined position. A leg support assembly operably coupled to the forward portion of the seat base, the leg support assembly is operable between a stowed position and a deployed position. The leg support including a first support assembly operably coupled to the forward portion of the seat base, the first support assembly is configured to extend to a first position when the leg support assembly is in the deployed position. A second support assembly operably coupled to the first support assembly, the second support assembly is configured to extend to a second position when the leg support assembly is in the deployed position, and a tread operably coupled to each of the first support assembly and the second support assembly.

Embodiments of the second aspect of the present disclosure can include any one or a combination of the following features:
a support cushion defining an interior arcuate portion, the treads are positioned proximate the interior arcuate portion such that the treads engage with the interior arcuate portion when the first support assembly is in the first position and the second support assembly is in the second position;
each of the first support assembly and the second support assembly extend 50 mm from the seat base at the first position;
the second support member extends 50 mm from the first position to the second position; and
the second support assembly extends to a third position when the first support assembly is in the first position.

According to a third aspect of the present disclosure, a leg support assembly for a vehicle includes a seat base operable between a seated position and a reclined position. A first support assembly operably coupled to the seat base, the first support assembly includes a first portion and a second portion. The first support assembly is translatable relative to the seat base. A second support assembly operably coupled to the second portion of the first support assembly. The second support assembly is translatable relative to the first support assembly, and an actuation assembly operably coupled to the seat base, the actuation assembly is configured to move the first support assembly and the second support assembly.
the first support assembly includes a first tread and the second support assembly includes a second tread, and each of the first tread and the second tread cover a portion of the first support assembly and the second support assembly, respectively; and
the actuation assembly includes a first actuator disposed in an interior of the first support assembly defined by the first portion and the second portion and a second actuator disposed in the second support assembly, each of the first actuator and the second actuator are configured to move the first support member and the second actuator, respectively.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a partial side perspective view of a vehicle seating assembly within an interior compartment of a vehicle;

FIG. 2 is a front side perspective view of a vehicle seating assembly including a seat base having a leg support assembly;

FIG. 3 is an exploded view of the seat base and a leg support assembly for a vehicle seating assembly;

FIG. 4 is an exploded view of the leg support assembly including a first and second support assembly and a seat pan;

FIG. 5 is an exploded view of the seat base frame and a seat pan including a linkage assembly configured to operate the seat base between a seated position and a reclined position;

FIG. 6A is a front plan view of the seat base including a first support assembly operably coupled to a seat pan;

FIG. 6B is a rear plan view of the seat base including a second support assembly operably coupled to a seat pan;

FIG. 7A is a partial side elevational view of a leg support assembly operably coupled to a seat base in the stowed position;

FIG. 7B is a partial side elevational view of the leg support assembly having a first support assembly and a second support assembly in a first position;

FIG. 7C is a partial side elevational view of the leg support assembly having a first support assembly in a first position and a second support assembly in a second position;

FIG. 7D is a partial side elevational view of the leg support assembly having a first support assembly in a first position and a second support assembly in a third position, where the leg support assembly is in a fully deployed position; and

FIG. 8 is a block diagram of the leg support assembly for a vehicle seating assembly.

### DETAILED DESCRIPTION OF PREFERRED EMBODIMENTS

Reference will now be made in detail to the present preferred embodiments of the disclosure, examples of which are illustrated in the accompanying drawings. Wherever possible, the same reference numerals will be used throughout the drawings to refer to the same or like parts. In the drawings, the depicted structural elements are not to scale and certain components are enlarged relative to the other components for purposes of emphasis and understanding.

As required, detailed embodiments of the present disclosure are disclosed herein; however, it is to be understood that the disclosed embodiments are merely exemplary of the disclosure that may be embodied in various and alternative forms. The figures are not necessarily to a detailed design; some schematics may be exaggerated or minimized to show function overview. Therefore, specific structural and functional details disclosed herein are not to be interpreted as limiting, but merely as a representative basis for teaching one skilled in the art to variously employ the present disclosure.

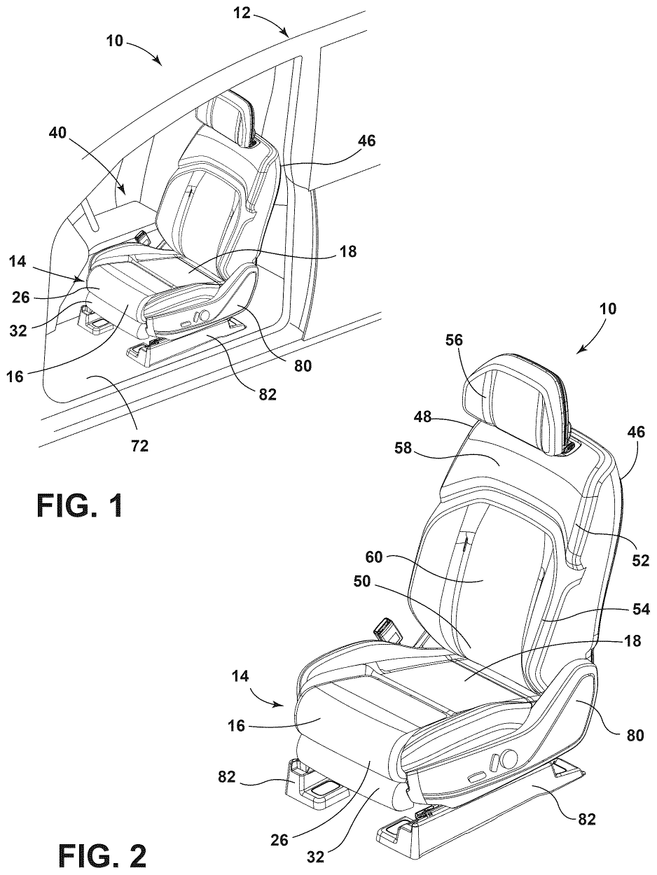

For purposes of description herein, the terms “upper,” “lower,” “right,” “left,” “rear,” “front,” “vertical,” “horizontal,” and derivatives thereof shall relate to the concepts as oriented in FIG. 1. However, it is to be understood that the concepts may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The present illustrated embodiments reside primarily in combinations of method steps and apparatus components related to a leg support for a vehicle seating assembly. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

As used herein, the term “and/or,” when used in a list of two or more items, means that any one of the listed items can be employed by itself, or any combination of two or more of the listed items, can be employed. For example, if a composition is described as containing components A, B, and/or C, the composition can contain A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

Referring to FIGS. 1-8, a reference numeral 10 generally designates a seating assembly 10 for a vehicle 12 that includes a seat base 14 having a forward portion 16 and a rearward portion 18. The seat base 14 is operable between a seated position and a reclined position. A seat pan 24 is operably coupled to the seat base 14. A first support assembly 26, also referred to herein as a thigh support assembly 26 includes a first portion 28 and a second portion 30. The first support assembly 26 is operably coupled to the seat pan 24 and is translatable relative to the seat pan 24. A second support assembly 32, also referred to herein as the calf support assembly 32 is operably coupled to the first support assembly 26 and is translatable relative to the first support assembly 26. The first support assembly 26 and the second support assembly 32 extend from the forward portion 16 of the seat base 14.

Referring now to FIG. 1, the vehicle 12 includes an interior compartment 40 which includes at least one seating assembly 10 for supporting passengers thereon. The vehicle 12 may be a sedan, a sport utility vehicle, a van, a truck, a crossover, or other styles of wheeled motor vehicles. The vehicle 12 may be a manually operated vehicle (e.g., operated with a human driver), a fully autonomous vehicle (e.g., operated without a human driver), or a partially autonomous vehicle (e.g., operated with or without a human driver). Additionally, the vehicle 12 may be utilized for personal and/or commercial purposes, such as for ride-providing services (e.g., chauffeuring), transporting, and/or ride-sharing services.

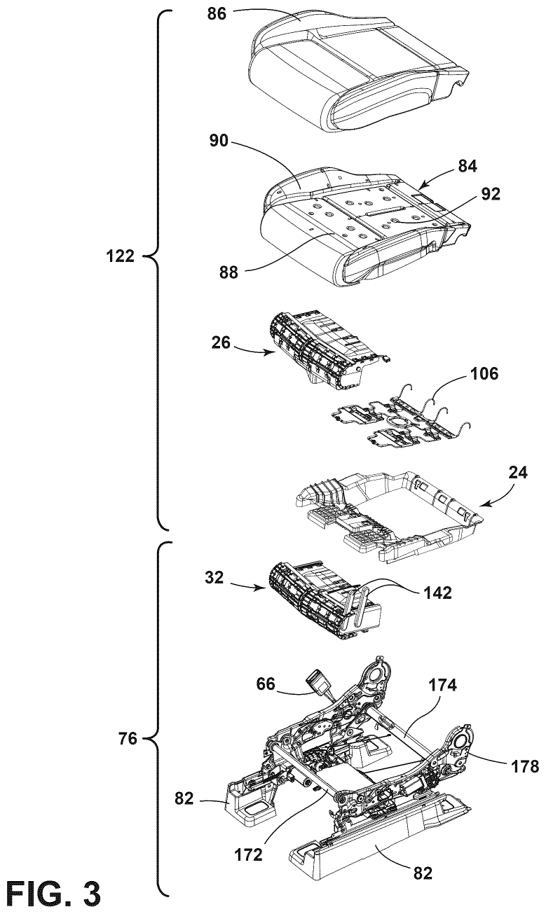

Referring still to FIG. 1, as well as FIG. 2, the vehicle seating assembly 10 includes the seat base 14 having the forward portion 16 and the rearward portion 18 and a seatback 46 having a top portion 48 and a bottom portion 50. The rearward portion 18 of the seat base 14 is positioned proximate the bottom portion 50 of the seatback 46, such that the seatback 46 is pivotal relative to the rearward portion 18 of the seat base 14. The seatback 46 includes both an upper seatback 52 and a lower seatback 54. The vehicle seating assembly 10 may also include a head restraint 56 that is disposed on the upper seatback 52. The head restraint 56 is moveable between a forward and rearward position to accommodate various sized heads of passengers, as well as different heights of passengers. The vehicle seating assembly 10 also includes controls specifically configured to adjust an upper thoracic portion 58 of the upper seatback 52 or a lower lumbar portion 60 of the lower seatback 54.

Additionally, a receiver 66 for a tether assembly is disposed on the vehicle seating assembly 10 to secure the passenger when seated. In addition, the vehicle seating assembly 10 is suspended on a rail slide assembly 68 that allows movement of the vehicle seating assembly 10 in fore and aft directions relative to the vehicle 12. The rail slide assembly 68 includes rails 70 that are secured on a vehicle floor 72. The rail slide assembly 68 also includes slides 74 which may be operably coupled with the vehicle seating assembly 10, in particular, a seat base frame 76. The slides 74 are in sliding engagement with the rails 70. Accordingly, a forward trim component and side trim pieces 80 may be disposed about the seat base 14 and base trim pieces 82 may be disposed about the seat base frame 76. The trim components cover the seat base frame 76 and structural components of the seat base 14, such as the rail slide assembly 68.

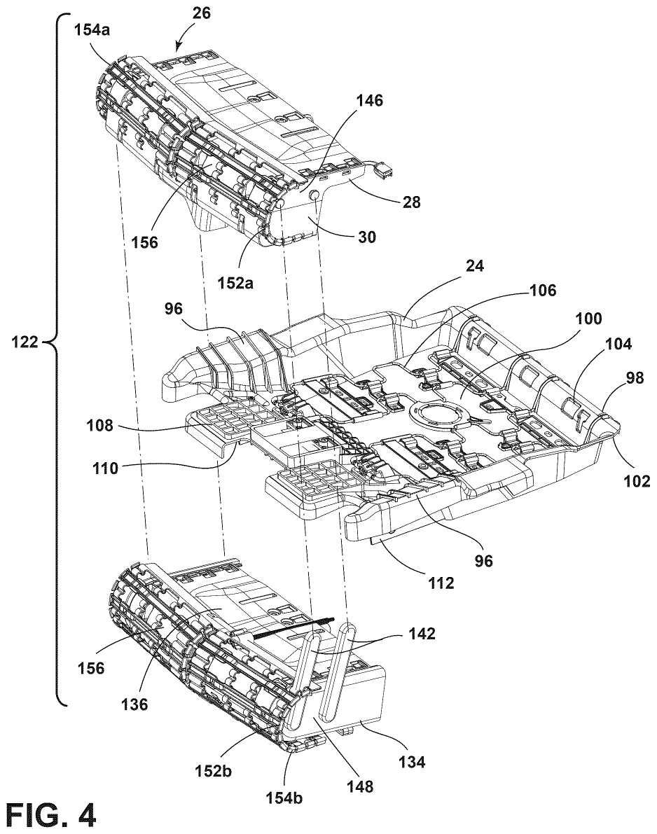

Referring still to FIG. 2, as well as FIG. 3, the vehicle seating assembly 10 includes various components configured to assist the seat base 14 in operating between the stowed position and the deployed position. For example, the seat base 14 includes the seat cushion with a cover stock 86 disposed thereon. The cover stock 86 may include different varieties over different portions of the seat cushion assembly 84. The seat cushion assembly 84 of the seat base 14 includes a main cushion 88 and seat side bolsters 90. The main cushion 88 and/or side bolsters 90 may include a plurality of ventilation holes 92 configured to allow air to pass through the seat base 14. Accordingly, a climate control system may be provided in the seat base 14 which can draw air from, or blow air through, the seat cushion assembly 84 and the cover stock 86.

The vehicle seating assembly 10 includes the seat pan 24 that is operably coupled with the seat base frame 76 and is positioned between the seat base frame 76 and the seat cushion assembly 84 with the cover stock 86 disposed thereon. The seat pan 24 may include side bolsters 96 that are configured to support and flex under stress to provide resiliency to the seat pan 24. Additionally, integrally forming the side bolsters 96 with the seat pan 24 increases structural support for the passenger during ingress and/or egress from the seating assembly 10 as well as during jounce and abuse loading circumstances. The seat pan 24 includes rearward support 98 that, along with the side bolsters 96, at least partially define an intermediate open area 100. The rearward support 98 of the seat pan 24 defines an arcuate portion 102 forming a rear engagement channel 104 configured to operably couple the seat pan 24, and consequently, the seat base 14 with the seat base frame 76. A suspension assembly 106 is disposed in the intermediate open area 100 and is configured to withstand both static and dynamic loads associated with seated passenger travel. Additionally, the seat pan 24 includes a top wall 108 and a bottom wall 110, where the bottom wall 110 includes at least one hooked tab 112 extending therefrom in a vehicle-forward direction. The at least one hooked tab 112 engages the seat base frame 76 to assist in coupling the seat base 14 to the seat base frame 76.

The vehicle seating assembly 10 may also include a variety of comfort controls. For example, a pivot control may be operably coupled to the seat base 14 to allow for pivoting movement of the seat base 14 and the seatback 46. Another example of comfort controls includes a leg support assembly 122 operable between a stowed position and a deployed position. The leg support assembly 122 includes the first support assembly 26, otherwise referred to herein as the thigh support assembly 26 or upper support assembly 26 and the second support assembly 32, otherwise referred to herein as the calf support assembly 32 or lower support assembly 32. The first support assembly 26 and the second support assembly 32 include a support cushion 128 configured to cover each of the first support assembly 26 and the second support assembly 32. The support cushion 128 is configured to be operably coupled to the forward end of the seat base 14. In other words, the support cushion 128 covers each of the first and second support assemblies 26, 32 to integrate the leg support assembly 122 into the forward portion 16 of the seat base 14. However, it is contemplated that the first support assembly 26 may include an individual thigh support cushion disposed thereon and the second support assembly 32 may include a calf support cushion disposed thereon. The thigh and calf support cushions are configured to wrap over the first and second support assemblies 26, 32, respectively, to provide comfort while supporting the passenger's thighs and calves.

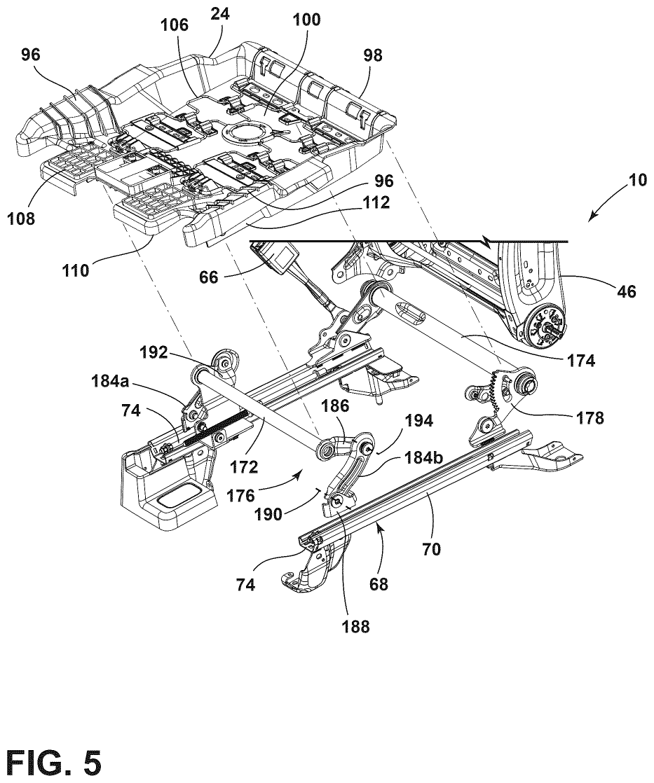

Referring still to FIG. 3, as well as FIG. 4, the first support assembly 26 is operably coupled to the seat pan 24 and the second support assembly 32 is operably coupled to the first support assembly 26. For example, the first support assembly 26 includes the first portion 28 operably coupled to the top wall 108 of the seat pan 24 and a second portion 30 operably coupled to the bottom wall 110 of the seat pan 24. Additionally, the second support assembly 32 includes a body 134 having a top surface 136 configured to slidably engage with the second portion 30 of the first support assembly 26. A pair of links 142 may be operably coupled to each of the first and second support assemblies 26, 32. For example, the pair of links 142 may be operably coupled to a side surface 146 of the first support assembly 26 positioned parallel to each other. The pair of links 142 may extend from the side surface 146 of the first support assembly 26 to a side surface 148 of the second support assembly 32 positioned directly below the side surface 146 of the first support assembly 26.

Each of the first support assembly 26 and the second support assembly 32 define a front arcuate portion 152a, 152b, respectively, configured to receive treads 154a, 154b or corrugated covers. Each of the treads 154a, 154b wrap around the front arcuate portions 152a, 152b to assist in maintaining the structure of the support cushion 128. The treads 154a, 154b of each of the first and second support assemblies 26, 32 engage with one another and may be configured to interact and/or mate with each other when each of the support assemblies 26, 32 move. However, it is contemplated that the treads 154a, 154b of each of the calf and thigh support assemblies 26, 32 may not interact with one another and may be configured to solely protect the front arcuate portion 152a, 152b of each of the first and second support assemblies 26, 32, respectively. Additionally, the treads 154a, 154b may include a foam portion 156 operably coupled thereto to provide structural support to each of the support assemblies 26, 32. The movement of the first and second support assemblies 26, 32 may create points of weakness throughout the support cushion 128. As such, the treads 154a, 154b including the foam portion 156 assist in providing tension across an interior surface 158 defined by the support cushion 128 to strengthen such weak points. The tension provided by the treads 154a, 154b and the foam portion 156 allow the leg support cushion 128 to reduce bunching or disfiguration during articulation or movement of the leg support assembly 122 and ingress/egress of the passenger.

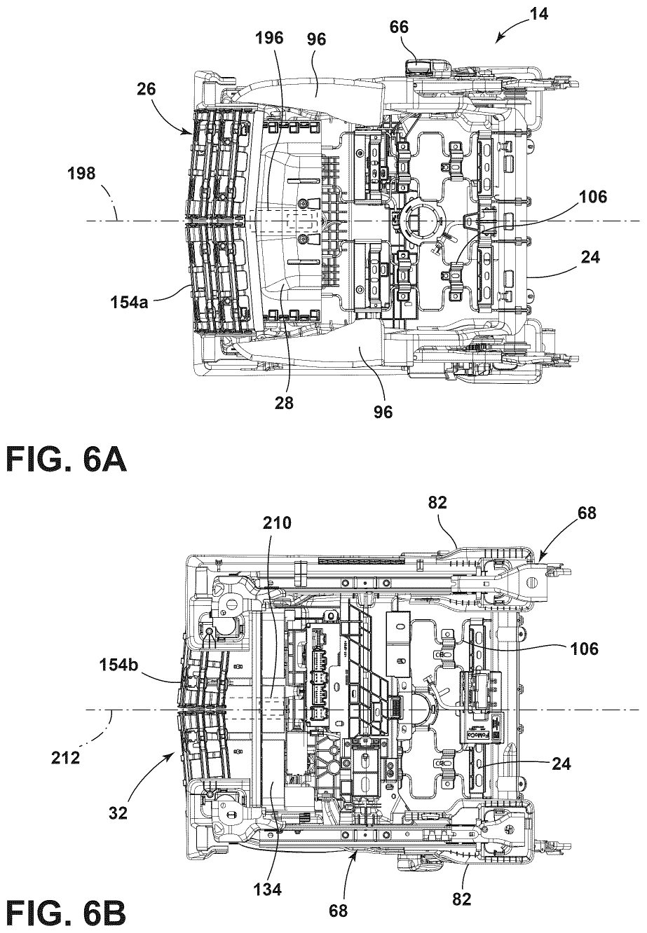

Referring now to FIG. 5, the vehicle seating assembly 10 includes the seat base frame 76 that operably couples the seat base 14 to the vehicle floor 72. The seat base frame 76 includes a front cross beam 172 proximate to and engaged with the first support assembly 26. The seat base frame 76 further includes a rear cross beam 174 proximate to the bottom portion 50 of the seatback 46 when the vehicle seating assembly 10 is fully assembled. The front cross beam 172 is operably coupled to a linkage assembly 176 that assists in the vertical displacement of the seat base 14 between the seated position in which the passenger may be seated and the reclined position in which the seat base 14 is adjusted such that the seat base 14 is at an angle. In other words, the engagement of the front cross beam 172 with the linkage assembly 176 assists in directing the forward portion 16 of the seat base 14 in an upward and/or a downward direction. Additionally, the rear cross beam 174 of the seat base frame 76 may be configured to engage with a rotation assembly 178 to adjust the rearward portion 18 of the seat base 14 in the generally upward and/or downward direction independent of the movement of the forward portion 16 of the seat base 14.

The vehicle seating assembly 10 is operable between the seated position and the reclined position with the assistance of the linkage assembly 176. The linkage assembly 176 includes opposing first links 184a, 184b having a first end and a second end. The second link 186 includes a first end and a second end. The first links 184a, 184b are positioned on the same plane at opposing lateral sides of the seat base frame 76. In various examples, the second end of the first links 184a, 184b are coupled to the slides 74 of the rail slide assembly 68 via coupling brackets 188, respectively, to form a rotational axis 190 rotating the opposing first links 184a, 184b in a vehicle-forward direction to the lift the seat base 14. The first end of the first link 184a may be operably coupled to a support bracket 192 of the seat base frame 76. As such, the first end of the front cross beam 172 may be operably coupled to the support bracket 192 proximate the first link 184a. Additionally, the first end of the first link 184b may be operably coupled to the second link 186 to form a rotational axis 194 by which the second link 186 rotates a vehicle-rearward direction to further lift the seat base 14.

Referring still to FIG. 5, during manufacturing, the seat base 14 is prepared for engagement with the seat base frame 76. In particular, the hooked tabs 112 of the seat pan 24 are configured to engage the front cross beam 172 to allow for rotation of the forward portion 16 of the seat base 14 about the front cross beam 172 in a generally downward direction towards the vehicle floor 72. As the seat pan 24 continues to rotate about the front cross beam 172 via the hooked tabs 112, the arcuate portion 102 of the rearward support 98 engages with the rear cross beam 174 of the seat base frame 76. In particular, as the seat base 14 is rotated downward into position, the rear engagement channel 104 of the rearward support 98 engages the rear cross beam 174. Once engaged, the linkage assembly 176 of the seat base frame 76 may adjust the forward portion 16 of the seat base 14 and the rotation assembly 178 of the seat base frame 76 may adjust the forward portion 16 and the rearward portion 18 of the seat base 14, respectively, to, from, or between the seated position and the reclined position.

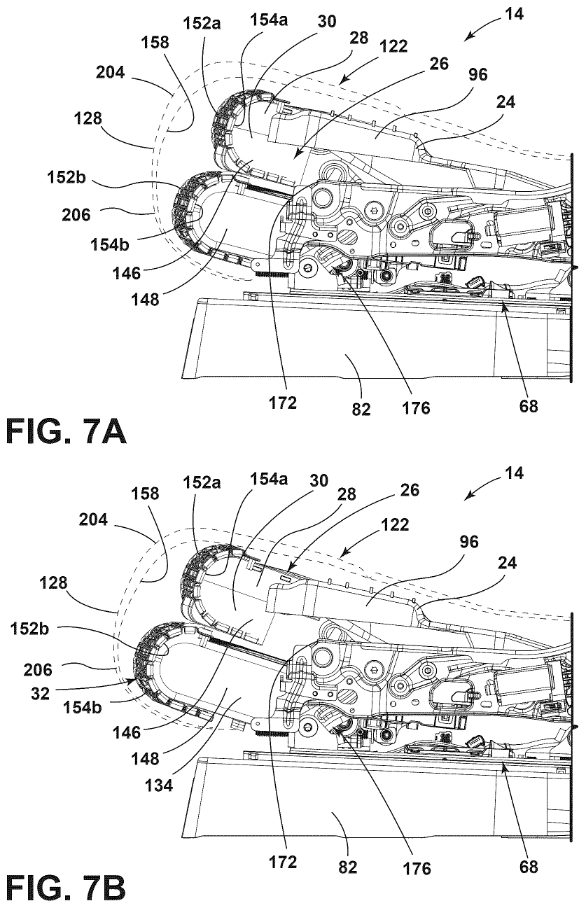

Referring now to FIG. 6A, the first support assembly 26 approximately spans the width of the top wall 108 of the seat pan 24 and may abut or may be in contact with the side bolsters 96 of the seat pan 24. However, it is contemplated that the first support assembly 26 may be spaced apart from the side bolsters 96 of the seat pan 24 such that the first support assembly 26 does not come in contact with the side bolsters 96. The first support assembly 26 includes a first actuation unit 196 disposed between the first portion 28 of the first support assembly 26 and the bottom wall 110 of the seat pan 24 to provide translational movement of the first support assembly 26 in a fore-aft direction relative to the seat pan 24 and, consequently, the seat base 14. The first support assembly 26 approximately spanning the width of the top wall 108 of the seat pan 24 allows for the first support assembly 26 to move as one, or as a single piece unit, between the fore-aft direction. In other words, one side of the first support assembly 26 may not move independently relative to another side of the first support assembly 26. Accordingly, the first actuation unit 196 may be centrally disposed (e.g., along a lateral midline 198 of the seat base 14) to provide for balanced fore-aft movement. In another example, the first actuation unit 196 includes a plurality of actuators distributed width-wise, with each actuator configured to drive one side of the first support assembly 26.

The first actuation unit 196 can include any electromechanical actuators and/or gearing coupled with a first actuator to allow the first actuator to interact with first support assembly 26. For example, the first actuator may be a motor 200 configured to drive a ball screw. The motor 200 may be housed in a cavity defined by the first portion 28 and the second portion 30 of the first support assembly 26 disposed on the lateral midline 198. The ball screw may extend into the first support assembly 26 whereby, upon rotation of a shaft of the motor 200, the ball screw drives the front arcuate portion 152a of the first support assembly 26 forward or rearward. However, it is contemplated that the motor 200 and ball screw arrangement is merely exemplary and non-limiting, other actuator mechanisms may be utilized. For example, the first actuation unit 196 may be a pneumatic system, pulley system, or any other mechanical interface provided to allow for manual and/or automatic translation of the first support assembly 26 relative to the seat pan 24.

Referring now to FIG. 6B, the body 134 of the second support assembly 32 approximately spans the width of the second portion 30 of the first support assembly 26. The second support assembly 32 includes a second actuation unit 210 disposed within the body 134 of the second support assembly 32 to provide translational movement of the second support assembly 32 in a fore-aft direction relative to the first support assembly 26. The second support assembly 32 moves as one, or as a single piece unit, between the fore-aft direction. In other words, one side of the second support assembly 32 may not move independently relative to another side of the second support assembly 32. However, it is contemplated that alternative constructions of the first and second support assemblies 26, 32 may allow for modular movement of opposing sides of each of the first and second support assemblies 26, 32. Accordingly, the second actuation unit 210 may be centrally disposed (e.g., along a lateral midline 212 of the seat base 14) to provide for balanced fore-aft movement. In another example, the second actuation unit 210 includes a plurality of actuators distributed width-wise, with each actuator configured to drive one side of the first support assembly 26. However, it is contemplated that each of the first actuation unit 196 and the second actuation unit 210 may be positioned along varying portions of the seat base 14 and/or along varying portions of each of the first and second support assemblies 26, 32.

The second actuation unit 210 can include any electromechanical actuators and/or gearing coupled with a second actuator to allow the second actuator to interact with second support assembly 32. For example, the second actuator, similar to the first actuator, may be a motor 214 configured to drive a ball screw. The motor 214 may be housed in a cavity defined by the body 134 of the second support assembly 32 disposed on the lateral midline 212. The ball screw may extend into the first support assembly 26 whereby, upon rotation of a shaft of the motor 214, the ball screw assists in driving the front arcuate portion 152b of the second support assembly 32 forward or rearward. However, it is contemplated that the motor 214 and ball screw arrangement is merely exemplary and non-limiting, other actuator mechanisms may be utilized. For example, the second actuation unit 210 may be a pneumatic system, pulley system, or any other mechanical interface provided to allow for manual and/or automatic translation of the second support assembly 32 relative to the first support assembly 26.

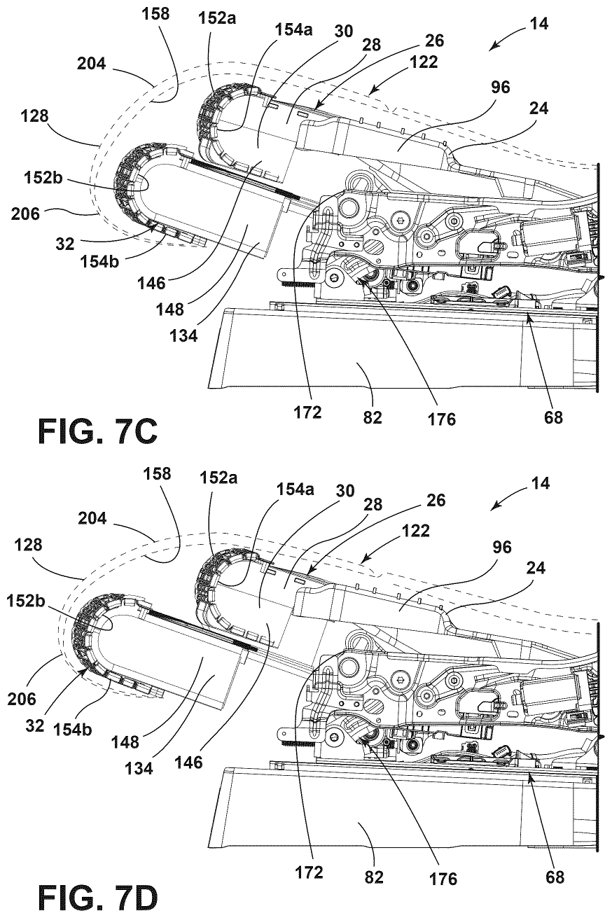

Referring now to FIGS. 7A-7D, the leg support assembly 122 of the vehicle seating assembly 10 is capable of moving to, from, and between the stowed position and the deployed position when the seat base 14 is operating between the seated position and the reclined position. The deployed position of the leg support assembly 122 and the reclined position of the seat base 14 of the vehicle seating assembly 10 is intended for use when the vehicle 12 is in a stationary (i.e., non-moving) state. The vehicle seating assembly 10 may be prevented from transitioning to the reclined position and/or the leg support assembly 122 from the deployed position if the vehicle 12 is not in a stationary state. For example, the vehicle 12 is in a stationary state while a transmission of the vehicle 12 is in a parked position. In the reclined position or the deployed position, an angular relationship between the seat base 14, the first support assembly 26, and the second support assembly 32 to the vehicle floor 72 can be adjusted. Varying degrees of inclination between the seat base 14 including the support assemblies 26, 32 relative to the vehicle floor 72 may increase when the vehicle seating assembly 10 is transitioned from the seated position to the reclined position and when the leg support assembly 122 is transitioned from the stowed position to the deployed position.

Referring still to the illustrated configurations depicted in FIGS. 7A-7D, an example motion between the stowed position and the deployed positions and the fore-aft movement of the leg support assembly 122, is depicted. In FIG. 7A, the seat base 14 is in the reclined position such that the seat pan 24 is at an incline relative to the vehicle floor 72. When the seat base 14 is in the reclined position, the leg support assembly 122 may adjust incrementally between the stowed position and the deployed position. However, it is contemplated that the leg support assembly 122 may be adjusted between the stowed and deployed positions depending on the desired usage of the passenger. As illustrated in FIG. 7A, each of the first support assembly 26 and the second support assembly 32 are maintained in the stowed position and are positioned equally along a vertical plane. In other words, each of the first and second support assemblies 26, 32 are positioned at an equal distance from the seat pan 24.

Referring now to the illustrated configuration depicted in FIG. 7B, each of the first and second support assemblies 26, 32 translate in a vehicle-forward direction via the first and second actuation units 196, 210, respectively, to a first position. Each of the support assemblies 26, 32 may travel in the vehicle-forward direction between approximately 1 mm to approximately 50 mm from the seat pan 24 to the first position. Accordingly, as the leg support assembly 122 adjusts to the first position, the treads 154a, 154b of each of the first and second support assemblies 26, 32 assist in maintaining tension along a width of interior surface 158 of the support cushion 128. As such, at the first position, legs of the passenger may be slightly elevated relative to the vehicle floor 72 when the seat base 14 is in the reclined position.

Referring now to the illustrated configuration depicted in FIG. 7C, as the seat base 14 is maintained in the reclined position, the first support assembly 26 is maintained in the first position at between approximately 1 mm and approximately 50 mm relative to the seat pan 24. The second support assembly 32 may continue to translate in the vehicle-forward direction via the second actuation unit 210 to a second position. However, it is contemplated that each of the first and second support assemblies 26, 32 may be adjusted to the second position. Accordingly, the second support assembly 32 may be extended an additional length between about 1 mm to about 50 mm relative to the first support assembly 26. As the second support assembly 32 is adjusted to the second position, a lower portion 206 of the support cushion 128 is independently moved in the fore direction relative to an upper portion 204 of the support cushion 128. In other words, the lower portion 206 of the support cushion 128 is moved in the fore direction relative to the upper portion 204 of the support cushion 128 which remains fixed. Accordingly, as the second support assembly 32 adjusts to the second position, the treads 154a, 154b of the second support assembly 32 assist in maintaining tension along a width of the lower portion 206 of the support cushion 128 and the first support assembly 26 assists in maintaining tension along a width of the upper portion 204 of the support cushion 128. As such, at the second position, calves of the passenger may be slightly elevated relative to the vehicle floor 72 and the thighs of the passenger remain supported when the seat base 14 is in the reclined position.

Referring now to the illustrated configuration depicted in FIG. 7D, the first support assembly 26 is maintained in the first position and the second support assembly 32 continues to translate in the vehicle-forward direction via the second actuation unit 210 to a third position or a fully deployed position of the leg support assembly 122. Accordingly, the second support assembly 32 may be extended an additional length between about 1 mm to about 50 mm from the second position to the third position relative to the first support assembly 26. As such, the second support assembly 32 may be adjusted between about 50 mm and about 150 mm between the stowed position and the deployed position of the leg support assembly 122. However, it is contemplated that each of the support assemblies 26, 32 may be adjusted a varying length between the stowed position and the deployed position based on the desired passenger usage. Additionally, as the second support assembly 32 is adjusted to the third position, the lower portion 206 of the support cushion 128 continues to move independently in the fore direction relative to the upper portion 204 of the support cushion 128. In other words, the lower portion 206 of the support cushion 128 is moved in the fore direction relative to the upper portion 204 of the support cushion 128 which remains fixed. Accordingly, as the second support assembly 32 adjusts to the third position, the treads 154b of the second support assembly 32 assist in maintaining tension along the width of the lower portion 206 of the support cushion 128 and the first support assembly 26 assists in maintaining tension along the width of the upper portion 204 of the support cushion 128. As such, at the third position, calves of the passenger may be further elevated from the second position to the third position relative to the vehicle floor 72. Additionally, the thighs of the passenger remain supported as the seat base 14 is maintained in the reclined position and as the leg support assembly 122 is maintained in the fully deployed position.

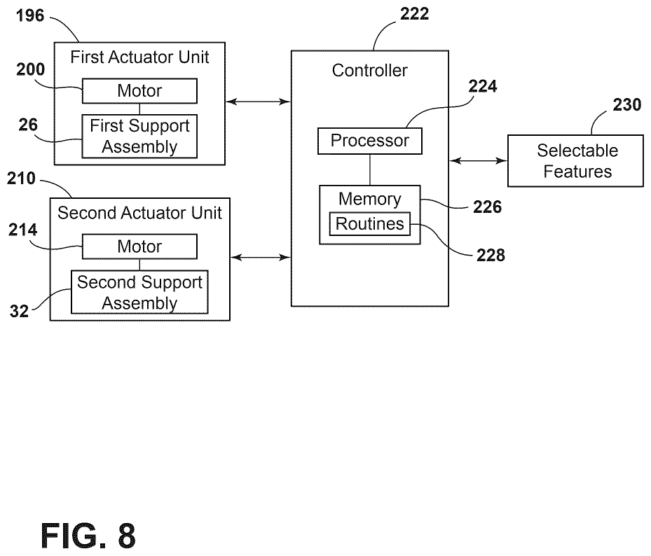

Referring to FIG. 8, the vehicle seating assembly 10 may include a controller 222 that has a processor 224, such as a microprocessor, memory 226, and other digital and/or analog control circuitry. Instructions or routines 228 are stored in the memory 226 and executable by the processor 224. The controller 222 is in communication with a user interface, which may include a display, such as a touch screen with use of inputs and output, or other selectable features 230 (e.g., buttons, switches, knobs, etc.). The passenger or user may input a selection into the user interface regarding the vehicle seating assembly 10 positioning of the seat base 14 between the seated position and the reclined position, and the leg support assembly 122 between the stowed position and the deployed position. The input is communicated to the controller 222, which may then activate the motors 200, 214.

The controller 222 may include the routine 228 for managing the transition between the seated position and the reclined position of the seat base 14 and the stowed position and the deployed position of the leg support assembly 122 of the vehicle seating assembly 10. When the passenger interacts with the selectable features 230, the controller 222 may activate the first actuation unit 196 of the first support assembly 26 and the second actuation unit 210 of the second support assembly 32 to adjust the leg support assembly 122 between the stowed position and the deployed position. Additionally, the controller 222 may coordinate the movement of the linkage assembly 176 via a motor, including the rotation of the first links 184a, 184b and the second link 186 about the rotational axes 190, 194, respectively. Simultaneously, the controller 222 may adjust the seatback 46 angle, rotating the seatback 46 in a vehicle-forward or a vehicle-rearward direction.

Use of the present device and system may provide for a variety of advantages. For example, vehicle seating assemblies are typically designed to meet a number of specifications that are dictated by the use of the seating assembly 10 within the interior compartment 40 of the vehicle 12. These specifications include, but are not limited to, spatial considerations within the interior compartment 40, passenger comfort, and user experience for a plurality of users within the interior compartment 40 (i.e., leg room). The vehicle seating assembly 10 of the present disclosure is operable between the reclined position and the seated position and includes the leg support assembly 122 which is operable between the stowed position and the deployed position. The operability of the leg support assembly 122, in tandem with the operability of the seat base 14, allows for a zero-gravity arrangement of the seating assembly 10. This arrangement may decrease a number of pressure points and/or an intensity of pressure points for the passenger seated in the vehicle seating assembly 10 while providing a more ergonomically comfortable arrangement than a conventional reclined position where the seatback 46 may be moved relative to the seat base 14 and the vehicle floor 72 in an isolated manner.

It is to be understood that variations and modifications can be made on the aforementioned structure without departing from the concepts of the present disclosure, and further it is to be understood that such concepts are intended to be covered by the following claims unless these claims by their language expressly state otherwise.

What is claimed is:

1. A vehicle seating assembly, comprising:
a seat base including a forward portion and a rearward portion, wherein the seat base is operable between a seated position and a reclined position;
a seat pan operably coupled to the seat base;
a first support assembly including a first portion and a second portion, wherein the first support assembly is operably coupled to the seat pan and is translatable relative to the seat pan; and
a second support assembly operably coupled to the first support assembly and translatable relative to the first support assembly, wherein the first support assembly and the second support assembly extend from the forward portion of the seat base.

2. The vehicle seating assembly of claim 1, wherein the first support assembly and the second support assembly are operable between stowed position when the seat base is in the seated position and a deployed position when the seat base is in the reclined position.

3. The vehicle seating assembly of claim 1, wherein the second support assembly includes a body having a top surface and a bottom surface, and wherein the top surface of the second support assembly engages the second portion of the first support assembly.

4. The vehicle seating assembly of claim 1, further comprising:
a first tread operably coupled to the first portion and the second portion of the first support assembly; and
a second tread operably coupled to the second support assembly, wherein each of the first tread and the second tread include a foam portion.

5. The vehicle seating assembly of claim 4, wherein the seat base has a support cushion that includes an upper portion and a lower portion to cover the first support assembly and the second support assembly, and wherein the first tread is positioned proximate the upper portion and the second tread is positioned proximate the lower portion of the support cushion.

6. The vehicle seating assembly of claim 5, wherein the upper portion and the lower portion of the support cushion define an arcuate surface, and wherein the first tread and the second tread are configured to form tension along the arcuate surface during movement of the first support assembly and the second support assembly.

7. The vehicle seating assembly of claim 1, wherein the first support assembly includes a first actuator disposed in a cavity defined by the first portion and the second portion.

8. The vehicle seating assembly of claim 3, wherein the body of the second support assembly defines an interior, and wherein a second actuator is disposed in the interior of the second support assembly.

9. The vehicle seating assembly of claim 1, wherein the first support assembly and the second support assembly are operable between a stowed position and a deployed position.

10. The vehicle seating assembly of claim 9, wherein the first support assembly and the second support assembly translate in a vehicle-forward direction to a first position when the seat base is in the reclined position and the first and second support assembly are in a partially deployed position.

11. The vehicle seating assembly of claim 10, wherein the second support assembly translates in a vehicle-forward direction to a second position such that the second support assembly extends beyond the first support assembly in the first position.

12. The vehicle seating assembly of claim 11, wherein the first support assembly and the second support assembly are in the deployed position when the first support assembly is in the first position and the second support assembly is in a third position.

13. A vehicle seating assembly, comprising:
a seat base including a forward portion and a rearward portion, wherein the seat base is operable between a seated position and a reclined position;
a leg support assembly operably coupled to the forward portion of the seat base, wherein the leg support assembly is operable between a stowed position and a deployed position, the leg support including:
a first support assembly operably coupled to the forward portion of the seat base, wherein the first support assembly is configured to extend to a first position when the leg support assembly is in the deployed position;
a second support assembly operably coupled to the first support assembly, wherein the second support assembly is configured to extend to a second position when the leg support assembly is in the deployed position; and
a tread operably coupled to each of the first support assembly and the second support assembly.

14. The vehicle seating assembly of claim 13, further comprising:
a support cushion defining an interior arcuate portion, wherein the tread is positioned proximate the interior arcuate portion such that the tread engages with the interior arcuate portion when the first support assembly is in the first position and the second support assembly is in the second position.

15. The vehicle seating assembly of claim 13, wherein each of the first support assembly and the second support assembly extend 50 mm from the seat base at the first position.

16. The vehicle seating assembly of claim 13, wherein the second support assembly extends 50 mm from the first position to the second position.

17. The vehicle seating assembly of claim 13, wherein the second support assembly extends to a third position when the first support assembly is in the first position.

18. A leg support assembly for a vehicle, comprising:
a seat base operable between a seated position and a reclined position;
a first support assembly operably coupled to the seat base, wherein the first support assembly includes a first portion and a second portion, and wherein the first support assembly is translatable relative to the seat base;
a second support assembly operably coupled to the second portion of the first support assembly, wherein the second support assembly is translatable relative to the first support assembly; and
an actuation assembly operably coupled to the seat base, wherein the actuation assembly is configured to move the first support assembly and the second support assembly.

19. The leg support assembly of claim 18, wherein the first support assembly includes a first tread and the second support assembly includes a second tread, and wherein each of the first tread and the second tread covers a portion of the first support assembly and the second support assembly, respectively.

20. The leg support assembly of claim 18, wherein the actuation assembly includes a first actuator disposed in an interior of the first support assembly defined by the first portion and the second portion and a second actuator disposed in the second support assembly, wherein each of the first actuator and the second actuator are configured to move the first support assembly and the second actuator, respectively.
